(19) United States
(12) Patent Application Publication
(10) Pub. No.: US 2017/0044769 A1
(43) Pub. Date: Feb. 16, 2017

(54) RADIANT BARRIER SYSTEM

(71) Applicant: Edward Fritz, Argyle, TX (US)

(72) Inventor: Edward Fritz, Argyle, TX (US)

(21) Appl. No.: 14/822,120

(22) Filed: Aug. 10, 2015

(51) Int. Cl. E04D 11/00; E04D 3/35; B32B 15/04; E04C 2/34; B32B 3/08; B32B 27/36; E04D 3/18; E04C 2/24

(52) U.S. Cl. CPC E04D 11/00; E04D 3/18; E04D 3/357; E04C 2/24; E04C 2/3405; B32B 3/085; B32B 27/36; B32B 15/04; B32B 2307/306; B32B 2419/06; B32B 2307/718

(57) ABSTRACT

A radiant barrier system may reduce heat flow into a structure. A radiant barrier system may include at least one internal airspace positioned between at least two radiant barrier layers having a reflectivity rating of at least 90%, the at least two radiant barrier layers comprising a layer positioned on top of the at least one internal airspace that reduces radiant heat flow by emissivity and a layer positioned below the at least one internal airspace that reduces radiant heat flow by reflectivity. A radiant barrier system may be incorporated between roofing products such as flexible roofing underlayments, sheet goods (i.e., plastic, metal or fiberglass), and wood products (i.e., plywood or oriented strand board (OSB)) and combinations thereof A radiant barrier system also may be integrated into wall products.

### FIELD OF THE DISCLOSURE

The present disclosure generally relates to a radiant barrier system, and more particularly, to a radiant barrier system having at least two radiant barrier layers and at least one internal airspace.

### BACKGROUND

Heat generally travels through a roofing assembly (typically shingles, underlayment, roof deck) by conduction. On a warm/sunny day, radiant heat from the sun can cause the shingles to reach a temperature of over 180° Fahrenheit. The bottom surface of the roof deck (i.e., the portion of the roof facing the attic) can reach temperatures in excess of 160° Fahrenheit. Because the composition of most roofing materials comprising a roofing assembly can be dense, heat easily moves through the roofing assembly by conduction. This offers the roofing assembly very little insulating quality or an ability to slow or to reduce heat moving through the roofing assembly. Accordingly, once the roof deck heats up, because of the high temperatures involved and the density of the roofing assembly, heat will radiate into an attic or heat will continue moving through the insulation and into the structure covered by the roofing assembly through conduction if there is insulation directly below the roof deck (such as in a structure having a cathedral ceiling or a foam-encapsulated attic).

Different means have been employed in the past to attempt to reduce conductive heat flow through a roofing assembly. For example, different forms of insulation may be incorporated into the roofing assembly. These insulation forms may include structural insulated panels (SIP) that are formed by OSB sheets sandwiching a layer of foam insulation or sheets of foam insulation between the shingles and the roof deck or on the bottom of the roof deck on top of the roof rafters. Ventilation may be increased inside an attic to keep the roof deck cooler. Reflective shingles and coatings have been used to reduce heat gained by the shingles, but they can be costly and the long-term effectiveness can be compromised due to dirt accumulation and/or direct exposure to weather elements.

Some forms of radiant barrier decking have been used. These are roof deck products that include a layer of aluminum foil (or a similar product) laminated/glued to the bottom of the material. The aluminum foil typically faces the attic space and works off the emissivity quality of aluminum foil. The challenge with this type of radiant barrier decking is that the roof deck will still get hot and a significant amount of the heat will still be emitted into the attic.

If the temperature of a ventilated roofing assembly can be reduced, not as much heat will be transferred to the objects below. Heat flow is determined based on the difference in temperature between two sides of an object (ΔT). As ΔT increases, more heat will flow. Introduction of a ventilated space between the shingles and the roof deck may help reduce conductive heat flow by cooling the layers above and below the air space because a layer of moving air is introduced into the assembly. However, unless the air space is “ventilated” it does not provide much of a cooling effect. Also, if the airspace is “dead,” inclusion of the airspace provides very little insulating quality. Ventilated airspace products have been available; however, these products tend to be relatively thick (more than ½″-1″) to provide adequate open space for air movement significant enough to produce any measureable cooling effect on the roofing assembly. In addition, installing these products can be challenging to provide a full and continuous path for air to move through the roofing assembly. Often, they are installed without a complete air pathway resulting in a “dead” air space. This is not very effective because when heat travels through a solid (by conduction) and encounters such an airspace, the heat can typically easily “jump” the airspace by converting to radiant energy.

### SUMMARY

Embodiments of the present disclosure may provide a radiant barrier system comprising at least one internal airspace positioned between at least two radiant barrier layers having a reflectivity rating of at least 90%, the at least two radiant barrier layers comprising a layer positioned on top of the at least one internal airspace that reduces radiant heat flow by emissivity and a layer positioned below the at least one internal airspace that reduces radiant heat flow by reflectivity. The at least two radiant barrier layers may be selected from the group comprising: aluminum, silver, gold, copper, a highly reflective metal sheet, a metalized polyethylene terephthalate (PET) film, and biaxially-oriented PET film (BoPET). The radiant barrier system may be installed under roof shingles to reduce heat flow into a roof deck. The radiant barrier system may be installed behind a wall to reduce heat passing through the wall. The radiant barrier system may further comprise a plurality of spacers that connect the at least two radiant barrier layers with the at least one internal airspace. The plurality of spacers may comprise less than 10% of the total surface area of the radiant barrier system. The radiant barrier system may have various thicknesses, but in an embodiment of the present disclosure, it may be no more than ¼″ tall. The radiant barrier system may weigh approximately 50-80 pounds per one-thousand square feet.

Other embodiments of the present disclosure may provide a radiant barrier system comprising at least two radiant barrier layers; at least one internal airspace positioned between the at least two radiant barrier layers, the at least two radiant barrier layers reducing heat flow through emissivity and reflectivity; and a plurality of spacers that connect the at least two radiant barrier layers with the at least one internal airspace. The radiant barrier system may be incorporated between roofing materials. The radiant barrier system may be integrated into a wall. The plurality of spacers may comprise less than 10% of the total surface area of the radiant barrier system.

Further embodiments of the present disclosure may provide a radiant barrier system, the system comprising: a plurality of radiant barrier layers; and a plurality of internal airspaces positioned between the plurality of radiant barrier layers. The plurality of radiant barrier layers may be selected from the group comprising: aluminum, silver, gold, copper, a highly reflective metal sheet, a metalized polyethylene terephthalate (PET) film, and biaxially-oriented PET film (BoPET). The plurality of radiant barrier layers may comprise a first radiant barrier layer affixed to a top substrate; and a second radiant barrier layer affixed to a bottom substrate. The plurality of radiant barrier layers may further comprise at least one additional radiant barrier layer disposed between the first radiant barrier layer and the second radiant barrier layer. The radiant barrier system may further comprise a plurality of spacers that connect the plurality of radiant barrier layers with the plurality of internal airspaces. The plurality of airspaces may be sealed or open on each end to create a dead or ventilated airspace, respectively. The system may be incorporated between traditional roofing products, the roofing products selected from the group comprising: flexible roofing underlayments, plastic sheet goods, metal sheet goods, fiberglass sheet goods, plywood products, oriented strand board (OSB) products and combinations thereof. The system may be integrated into a wall product.

Other technical features may be readily apparent to one skilled in the art from the following figures, descriptions and claims.

### BRIEF DESCRIPTION OF THE DRAWINGS

For a more complete understanding of this disclosure, reference is now made to the following description, taken in conjunction with the accompanying drawings, in which:

FIG. 1A depicts a radiant barrier system having four radiant barrier layers and two airspaces according to an embodiment of the present disclosure;

FIG. 1B depicts a side view of the radiant barrier system of FIG. 1A according to an embodiment of the present disclosure;

FIG. 2A depicts a radiant barrier system having two radiant barrier layers and one airspace according to an embodiment of the present disclosure;

FIG. 2B depicts a side view of the radiant barrier system of FIG. 2A according to an embodiment of the present disclosure; and

FIG. 3 depicts a radiant barrier system having four radiant barrier layers and two airspaces under a shingle roof over a standard wood roof deck according to an embodiment of the present disclosure.

### DETAILED DESCRIPTION

Embodiments of the present disclosure may provide a radiant barrier system that may reduce heat flow into a structure. In some embodiments of the present disclosure, a radiant barrier system may include at least two radiant barrier layers and at least one internal airspace; however, there may be multiple radiant barrier layers and multiple internal airspaces in a radiant barrier system without departing from the present disclosure. A radiant barrier system according to embodiments of the present disclosure may be incorporated between roofing products such as flexible roofing underlayments, sheet goods (i.e., plastic, metal or fiberglass), and wood products (i.e., plywood or oriented strand board (OSB)) and combinations thereof In other embodiments of the present disclosure, a radiant barrier system may be integrated into wall products.

Roofing products typically have a very high emissivity rating, meaning that the energy stored as heat can easily be converted to radiant heat. Radiant heat is defined as heat that is transmitted by non-contact, or heat transfer from one object to another without the two objects ever touching. This is a very efficient form of heat transfer, and the heat will radiate from one surface (i.e., a surface that may be hotter) and be absorbed by the other surface (i.e., a surface that may be cooler). However, embodiments of the present disclosure may provide a radiant barrier system that may significantly reduce the amount of radiant heat transfer across the airspace by introducing radiant barrier layers with low emissivity and high reflectivity.

The term “radiant barrier” is generally used to describe a product that has the ability to reflect over 90% of radiant energy. These are usually very thin layers of highly polished metals or metalized film. For example, a thin layer of highly polished aluminum foil typically has a reflectivity rating of 97%. Silver typically has a reflectivity rating of 98%, and gold may have a reflectivity rating of 99%. Other metals, such as copper, may have a similar reflectivity rating. Radiant barriers may provide emissivity, which is a quality indicating it is not easy to convert stored energy into radiant heat or to emit radiant heat.

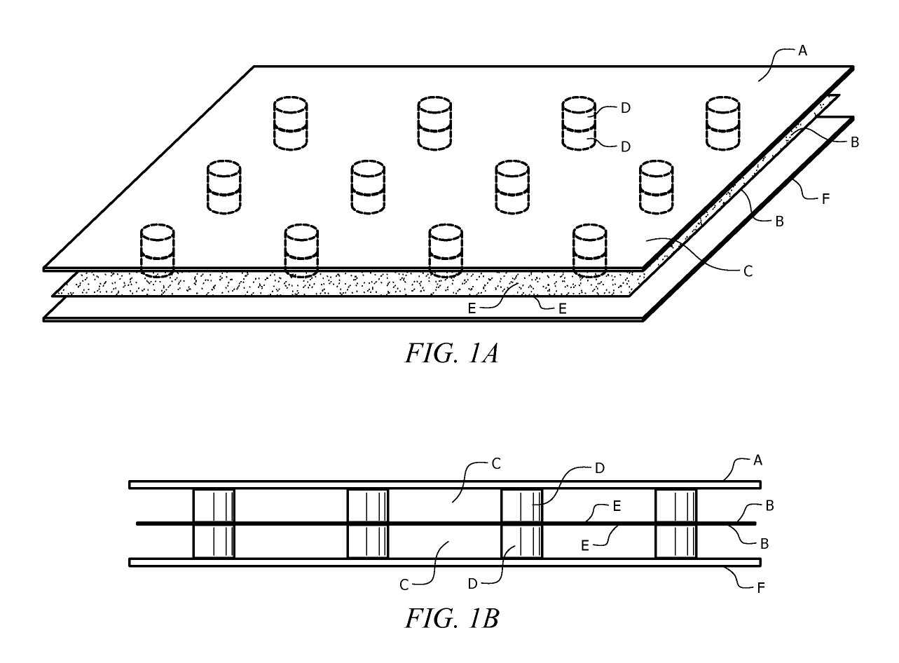

FIG. 1A depicts a radiant barrier system having four radiant barrier layers and two airspaces according to an embodiment of the present disclosure, and FIG. 1B depicts a side view of the radiant barrier system of FIG. 1A according to an embodiment of the present disclosure. As depicted in FIG. 1B, exterior/top substrate A may include but is not limited to a woven polyethylene fabric, a roofing underlayment (felt or synthetic), and/or rigid sheet goods (including but not limited to plastic, plywood, OSB, medium-density fiberboard (MDF), and thermoformed sheeting). Radiant barrier layer B may be a sheet of aluminum foil or other highly reflective sheet or metalized polyethylene terephthalate (PET) film. Radiant barrier layer B may be laminated or glued on one side to exterior/top substrate A. Airspace C may be an air channel/space positioned next to radiant barrier layer B that allows air to flow between the other layers comprising the radiant barrier system, or it can be sealed on the ends to create a dead airspace according to embodiments of the present disclosure. Spacers D may be a part of the radiant barrier system that connects the other layers of the radiant barrier system together with minimal contact surface area according to embodiments of the present disclosure. Radiant barrier layer E may be a sheet of aluminum foil or other highly reflective sheet or metalized polyethylene terephthalate (PET) film as previously described with respect to radiant barrier layer B. Bottom/interior substrate F may be formed of materials similar to those materials discussed with respect to exterior/top substrate A. While only two radiant barrier layers B, E have been described, it should be appreciated that additional radiant barrier layers may be disposed within a radiant barrier system, with internal airspaces disposed between them, without departing from the present disclosure.

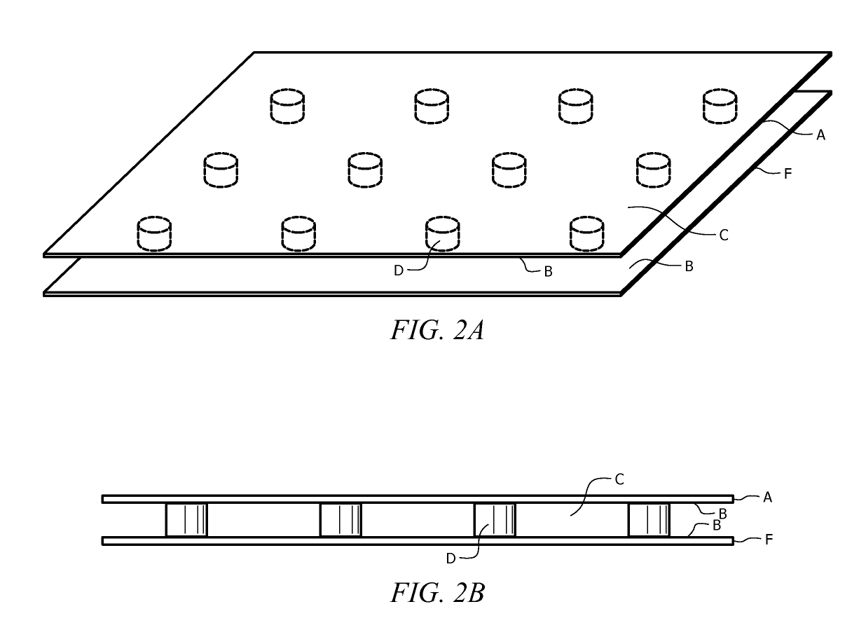

FIG. 2A depicts a radiant barrier system having two radiant barrier layers and one airspace according to an embodiment of the present disclosure. FIG. 2B depicts a side view of the radiant barrier system of FIG. 2A according to an embodiment of the present disclosure. The components of the radiant barrier system depicted in FIGS. 2A and 2B are the same as previously described with respect to FIGS. 1A and 1B.

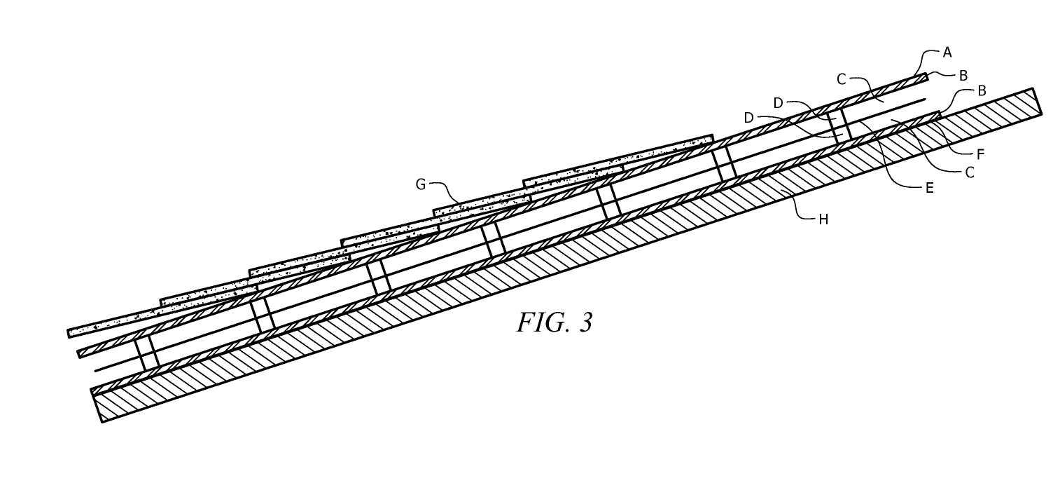

FIG. 3 depicts a radiant barrier system having four radiant barrier layers and two airspaces under a shingle roof over a standard wood roof deck according to an embodiment of the present disclosure. In addition to the components of the radiant barrier system previously described with respect to FIGS. 1A-2B, FIG. 3 depicts shingle roof G that may be applied to the top of the radiant barrier system according to embodiments of the present disclosure. Roof deck H also is depicted in FIG. 3, and it may generally be roof wood decking material; however, there may be embodiments of the present disclosure wherein roof deck H may be comprised of other materials without departing from the present disclosure.

As previously discussed, a radiant barrier system according to embodiments of the present disclosure may include multiple layers of radiant barrier on both sides of at least one internal airspace. In some embodiments of the present disclosure, a radiant barrier system may be incorporated into an assembly with multiple airspaces and layers of radiant barrier on each side of each airspace. By using multiple layers of radiant barrier, the radiant barrier system according to embodiments of the present disclosure may utilize both the reflectivity and emissivity qualities of the radiant barrier layers. This may provide a beneficial effect to significantly reduce radiant heat flow when compared to radiant barriers having a single reflective layer.

With the introduction of an internal airspace having a radiant barrier layer on each side of the internal airspace, the ability for heat to convert to radiant energy and “jump” the airspace may be significantly reduced. As heat conducts through a roofing assembly, heat may encounter a first radiant barrier layer. Because of the emissivity qualities of the radiant barrier layer, this radiant barrier layer may impede the release of radiant energy into the internal airspace. Then, the radiant barrier layer on the other side of the internal airspace may reflect much of the radiant energy back toward the source (top) because of the reflectivity qualities of the radiant barrier layer. This may further reduce the amount of heat/energy going through the roofing assembly according to embodiments of the present disclosure. By introducing at least one internal airspace and at least two radiant barrier layers, a radiant barrier system according to embodiments of the present disclosure may greatly reduce the total amount of heat getting through the radiant barrier system. Accordingly, the roof deck located below the radiant barrier system and below the shingles may remain significantly cooler compared to a roof not utilizing the radiant barrier system. When the roof deck remains cooler, as it does when utilizing the radiant barrier system according to embodiments of the present disclosure, ultimately less heat may be transferred further into the structure and contents below the roof deck.

Embodiments of the present disclosure may provide a radiant barrier system wherein multiple radiant barrier layers may be installed under standard-type shingles to significantly reduce the heat flow into the roof deck. The reduction heat transfer may be significantly more than simply putting a radiant barrier to the inside of (below) the roof deck. A radiant barrier system according to embodiments of the present disclosure may be easily installed in a roll-out product or as individual sheets. In some embodiments of the present disclosure, a radiant barrier system may be used behind stucco walls to create a ventilated internal airspace with multiple radiant barriers. This may significantly reduce heat passing through a wall that may be in direct sunlight, thereby receiving high levels of radiant heat.

Embodiments of the present disclosure may provide a radiant barrier system having a multilayered assembly comprised of different types of materials. While different materials may be used in the different layers of a radiant barrier system according to embodiments of the present disclosure, the radiant barrier system may have a common element of having at least two layers of radiant barrier. The layers of radiant barrier may be comprised of a material having a reflectivity radiant of over 90%. Such materials may include but are not limited to, polished sheets of aluminum foil, silver, gold, and copper. In some embodiments of the present disclosure, the materials may include polyethylene terephthalate (PET) film, such as mylar, melinex or hostaphan, or biaxially-oriented polyethylene terephthalate (BoPET) film; however, other similar materials may be utilized without departing from the present disclosure. When a radiant barrier system according to embodiments of the present disclosure is formed, the system may be as thin as ¼″ or less; however, it should be appreciated that there may be other embodiments of the present disclosure wherein the thickness may vary, such as from ⅛″ to 1″.

It should be appreciated that multiple layers forming a radiant barrier system according to embodiments of the present disclosure may be connected using a plurality of small spacers. Spacers may be used to provide a constant airspace between the layers of radiant barrier. It should be appreciated that the spacers may comprise a relatively small amount of the total surface area of the radiant barrier system, and in some embodiments of the present disclosure, the spacers may comprise less than 10% of the total surface area. This may maximize the open space and the areas where the layers of radiant barrier can face an internal airspace. The spacers should cover a minimal amount of the total surface area to minimize paths that allow conductive heat. It should be appreciated that the spacers should be rigid enough and close enough to support the different layers of the radiant barrier system. This may allow an airspace to be maintained to provide air movement between the layers of radiant barrier. It also may provide support from compression due to weight placed on top. For example, the spacers below a shingle may be rigid and positioned close enough to one another so that if someone were to walk on the roof, the roof would not be compressed, causing them to collapse or close. The spacers can be made from different materials, including but not limited to plastic, foam and wood. Spacers may provide relatively high strength to support weight while still being lightweight. The shape of the spacers may include but is not limited to, round (or somewhat donut-shaped), strip-shaped, bead or droplet-shaped, or a mesh-type product with integrated spacers. It should be appreciated that the size and/or shape of the spacer may be dependent on the use of the product and how much weight it will be supporting. The individual spacers may generally be between ⅛″ to ½″ in diameter with some applications requiring larger, smaller, or differently shaped spacers. However, it should be appreciated that the size and shape of the spacers may vary depending on the application, the manufacturing process, and other factors without departing from the present disclosure.

It should be appreciated that by including multiple layers of radiant barrier within the radiant barrier system may force heat to go through several layers to get to the other side. Each additional layer makes it more difficult for heat to go through, and this may significantly increase the effectiveness of the radiant barrier system relative to products that have been available that have only one radiant barrier layer.

A radiant barrier system according to embodiments of the present disclosure may be formed as a flexible roll product that acts as a radiant barrier, and it can be installed directly between a standard roof deck and either shingles or flat metal panel roofing (typically called “standing steam” roofing systems). Typically a radiant barrier may not be employed directly under shingles since there is no airspace. A radiant barrier system according to embodiments of the present disclosure may create an airspace while still maintaining maximum “open area.” Spacers may lift the shingles off the roof deck, yet still allow for a normal roof installation. By introducing the airspace, heat may transfer through the shingles, and then upon reaching the created airspace, the heat may be converted to radiant heat to pass through the airspace. This may enable the radiant heat to be reflected away from the roof deck and may reduce the heat flow into the roof deck and the structure below the roof deck.

It should be appreciated that a radiant barrier system according to embodiments of the present disclosure may cast or otherwise adhere the spacers to a radiant barrier layer. The spacers may also be created by using a roll forming method, liquid applied foam or other plastic, integrating pre-formed injection molded mesh with integrated spacers or cut or fabricated wooden spacers. However, it should be appreciated that other methods for forming spacers may be employed without departing from the present disclosure. It also should be appreciated that the radiant barrier system according to embodiments of the present disclosure may be flexible and easy to cut even using a standard utility knife. It may further be appreciated that the radiant barrier system has a low thickness, typically less than ¼″ tall, and it may be relatively lightweight (approximately 50-80 pounds per thousand square feet).

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A radiant barrier system, the system comprising:
at least one internal airspace positioned between at least two radiant barrier layers having a reflectivity rating of at least 90%, the at least two radiant barrier layers comprising a layer positioned on top of the at least one internal airspace that reduces radiant heat flow by emissivity and a layer positioned below the at least one internal airspace that reduces radiant heat flow by reflectivity.

2. The radiant barrier system of claim 1 wherein the at least two radiant barrier layers are selected from the group comprising:
aluminum, silver, gold, copper, a highly reflective metal sheet, a metalized polyethylene terephthalate (PET) film, and biaxially-oriented PET film (BoPET).

3. The radiant barrier system of claim 1 wherein the radiant barrier system is installed under roof shingles to reduce heat flow into a roof deck.

4. The radiant barrier system of claim 1 wherein the radiant barrier system is installed behind a wall to reduce heat passing through the wall.

5. The radiant barrier system of claim 1 further comprising:
a plurality of spacers that connect the at least two radiant barrier layers with the at least one internal airspace.

6. The radiant barrier system of claim 5 wherein the plurality of spacers comprise less than 10% of the total surface area of the radiant barrier system.

7. The radiant barrier system of claim 1 wherein the radiant barrier system is no more than ¼″ tall.

8. The radiant barrier system of claim 1 wherein the radiant barrier system weighs approximately 50-80 pounds per thousand square feet.

9. A radiant barrier system, the system comprising:
at least two radiant barrier layers;
at least one internal airspace positioned between the at least two radiant barrier layers, the at least two radiant barrier layers reducing heat flow through emissivity and reflectivity; and
a plurality of spacers that connect the at least two radiant barrier layers with the at least one internal airspace.

10. The radiant barrier system of claim 9 wherein the radiant barrier system is incorporated between roofing materials.

11. The radiant barrier system of claim 9 wherein the radiant barrier system is integrated into a wall.

12. The radiant barrier system of claim 9 wherein the plurality of spacers comprise less than 10% of the total surface area of the radiant barrier system.

13. A radiant barrier system, the system comprising:
a plurality of radiant barrier layers; and
a plurality of internal airspaces positioned between the plurality of radiant barrier layers.

14. The radiant barrier system of claim 13, the plurality of radiant barrier layers selected from the group comprising:
aluminum, silver, gold, copper, a highly reflective metal sheet, a metalized polyethylene terephthalate (PET) film, and biaxially-oriented PET film (BoPET).

15. The radiant barrier system of claim 13, the plurality of radiant barrier layers comprising:
a first radiant barrier layer affixed to a top substrate; and
a second radiant barrier layer affixed to a bottom substrate.

16. The radiant barrier system of claim 15, the plurality of radiant barrier layers further comprising:
at least one additional radiant barrier layer disposed between the first radiant barrier layer and the second radiant barrier layer.

17. The radiant barrier system of claim 13 further comprising:
a plurality of spacers that connect the plurality of radiant barrier layers with the plurality of internal airspaces.

18. The radiant barrier system of claim 13 wherein the plurality of airspaces are sealed on each end to create a dead airspace.

19. The radiant barrier system of claim 13 wherein the system is incorporated between roofing products, the roofing products selected from the group comprising:
flexible roofing underlayments, plastic sheet goods, metal sheet goods, fiberglass sheet goods, plywood products, oriented strand board (OSB) products and combinations thereof.

20. The radiant barrier system of claim 13 wherein the system is integrated into a wall product.
